(19) United States
(12) Patent Application Publication
(10) Pub. No.: US 2025/0033256 A1
(43) Pub. Date: Jan. 30, 2025

(54) MOLDS FOR COMPOUND INJECTION MOLDING AND A METHOD THEREOF

(71) Applicant: BingHua WU, Fujian (CN)

(72) Inventor: BingHua WU, Fujian (CN)

(21) Appl. No.: 18/663,105

(22) Filed: May 14, 2024

(30) Foreign Application Priority Data
Jul. 24, 2023 (CN) 202310910410.9

(51) Int. Cl. B29C 45/00; B29L 31/22

(52) U.S. Cl. CPC B29C 45/0062; B29L 2031/22

(57) ABSTRACT

Molds for compound injection molding, including at least a first mold, a second mold, and a third mold; the first mold has a first mold cavity for injection molding of a first component; the second mold has a shielding cavity for shielding the first component and a second mold cavity for injection molding of a second component; the third mold has positioning cavities for positioning the first component and the second component, and a third mold cavity for injection molding of a third component; the positioning cavities are in communication with the third mold cavity, so that the third component can be connected integrally with the first component and the second component to form a one whole piece of product.

### TECHNICAL FIELD

The present invention relates to the technical field of injection molding, and in particular to molds for compound injection molding, and a method thereof.

### BACKGROUND OF THE INVENTION

A conventional injection molding process for materials with two different colors is a molding process in which the two different materials of different colors are molded in a same mold, so that the resulting injection-molded product is formed by the two different materials. For products having more than two components whose colors and/or materials are different, each component has to be formed in an individual mold, and then all the components are assembled and connected integrally as a whole. However, such a production process is complex, inefficient, and may easily damage the resulting products causing an increased rate of defective products. Therefore, the conventional technology is hard to meet the production requirements nowadays.

### BRIEF SUMMARY OF THE INVENTION

It is an object of the present invention to provide molds for compound injection molding, and a method thereof, to solve the problems described in the background. In order to achieve the above object, the present invention provides the following technical solutions:

A first aspect of the present invention provides molds for compound injection molding, comprising at least a first mold, a second mold, and a third mold; the first mold is provided with a first mold cavity for forming a first component by injection molding; the second mold is provided with a shielding cavity for shielding the first component and a second mold cavity for forming a second component by injection molding; the third mold is provided with positioning cavities for positioning the first component and the second component, and a third mold cavity for forming a third component by injection molding; the positioning cavities are in communication with the third mold cavity. A melting point of a plastic injected into the third mold cavity is lower than that of a plastic injected into the first mold cavity and a plastic injected into the second mold cavity. Accordingly, the plastic injected into the third mold cavity, which is injected at a time later than injection of the plastic into the first mold cavity and also injection of the plastic into the second mold cavity, does not cause the plastic injected into the first mold cavity and the plastic injected into the second mold cavity to melt and mix together, and the plastic injected into the first mold cavity and the plastic injected into the second mold cavity will not be chemically dissolved and mixed together with each other and with the plastic injected into the third mold cavity due to chemical characteristics of the plastic injected into the third mold cavity. In this way, independency and integrity of each component are maintained, so that the third component is connected integrally with the first component and the second component to form a one whole piece of product.

According to an embodiment of the present application, when a single product to be manufactured needs three or more colors or materials, the first mold is first used, where a first material is injected into the first mold cavity to form the first component by injection molding; then, the second mold is used, where the first component is shielded by using the shielding cavity of the second mold to block communication between the second mold cavity and the first component, and a second material is injected into the second mold cavity to form the second component by injection molding, thereby avoiding the risk of material overflown or mutual dissolution during the injection molding process; after the first component and the second component are formed, the third mold is used, where a third material is injected into the third mold cavity to form the third component by injection molding. In this way, the object of forming a single product with a plurality of colors and/or a plurality of materials by injection molding is achieved. (In case more than three different components are manufactured, additional molds with corresponding shielding cavities may be used, each being provided with a molding cavity for injection molding of a further component, while the shielding cavities of each additional mold are used for shielding the components previously molded by injection molding in previous molds; a quantity of additional molds being used is determined by practical needs so that more than three components of different colors and/or materials can be manufactured.) Also, because the positioning cavities are in communication with the third mold cavity, the third component as formed is connected integrally with the first component and the second component to form a one whole piece, thereby omitting a step of assembly after injection molding, improving production efficiency, reducing production and assembly costs, and reducing the rate of defective products. In addition, an assembly clearance between the components is not required to be adjusted, and a zero clearance between the components is achieved, thereby reducing adjustments of the assembly clearance between the components, and improving the sealing performance of the product. The process according to the present invention is suitable to be used as a packaging process of some electronic circuits.

Further, each of the molds comprises an upper mold and a lower mold, and both the mold cavity and the shielding cavity (if applicable) of each of the molds are disposed between the upper mold and the lower mold.

Further, a shielding volume of the shielding cavity is larger than a volume of the component (as defined by an outer contour of the component) shielded by the shielding cavity. In case of an irregular component, the shielding cavity may be designed to have a regular geometric shape, for example a cylindrical shape or a cuboid, with a shielding volume larger than the volume of the irregular component, thereby simplifying the manufacturing of the mold, facilitating fast shielding in an injection molding process, and reducing trouble of alignment and calibration.

A second aspect of the present invention provides a method of compound injection molding using the above described molds.

Further, the method comprises the following steps:
S1: making the first component in the first mold cavity of the first mold by injection molding;
S2: making the second component in the second mold cavity of the second mold by injection molding, while the first component is shielded by the shielding cavity of the second mold during injection molding of the second component;
S3: placing the first component and the second component in the positioning cavities of the third mold, and making the third component in the third mold cavity of the third mold by injection molding, so that the third component is integrally connected with the first component and the second component in a one whole piece.

Further, a melting point of a plastic injected into the third mold cavity is lower than that of a plastic injected into the first mold cavity and a plastic injected into the plastic injected into the second mold cavity, and the plastic injected into the first mold cavity, the plastic injected into the second mold cavity, and the plastic injected into the third mold cavity do not mutually dissolve. Specifically, by making use of the physical properties that different types of plastics have different melting points, and the chemical characteristic that the plastics do not mutually dissolve, independency and integrity of each component are maintained, and the components in the resulting injection-molded product may also be movable relative to one another. Therefore, the present invention is suitable for manufacturing a product with a plurality of movable joints, and may reduce manufacturing costs of the molds.

The present invention has the following beneficial effects: Production cost of the molds of the present invention is low, the process is simple, the present invention is suitable for manufacturing a product with a different colors and/or different materials and/or a plurality of joints, and production efficiency and yield rate are improved.

### BRIEF DESCRIPTION OF THE DRAWINGS

In order to describe the technical solutions according to the embodiments of the present invention more clearly, the following briefly describes the accompanying drawings required in the embodiments. It is clear that the accompanying drawings in the following description show merely some but not all of the embodiments of the present invention, and those of ordinary skill in the art may still derive other drawings from these accompanying drawings given that no inventive effort is required.

FIG. 1 is a schematic structural diagram of molds according to Embodiment 1 of the present invention.

FIG. 2 is a schematic structural diagram of a product manufactured according to Embodiment 1 of the present invention.

FIG. 3 is a schematic structural diagram of molds according to Embodiment 2 of the present invention.

FIG. 4 is a schematic structural diagram of a product manufactured according to Embodiment 2 of the present invention.

FIG. 5 is a schematic diagram showing the movable joints of the product manufactured according to Embodiment 2 of the present invention in a rotated state.

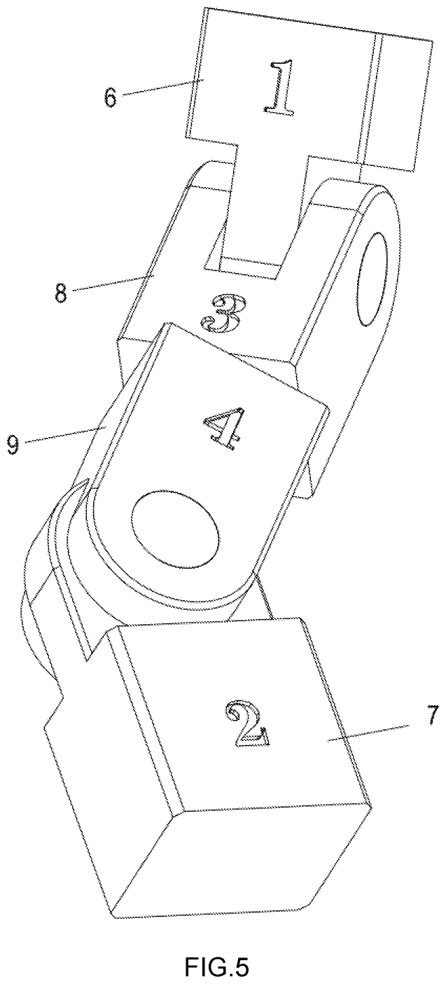

It should be noted that the accompanying drawings are not necessarily drawn to scale, but are merely shown in a schematic manner which is not detrimental to the understanding of a reader.

### DETAILED DESCRIPTION OF THE INVENTION

### Embodiment 1

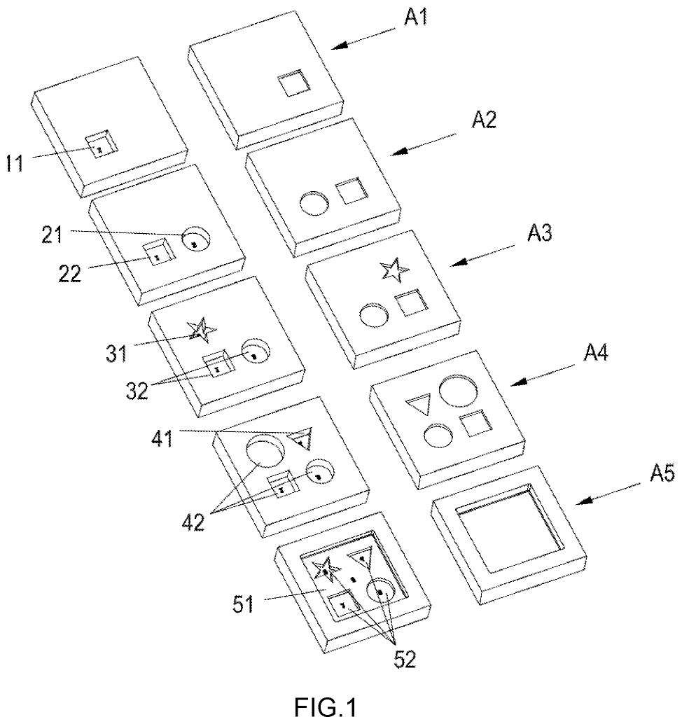

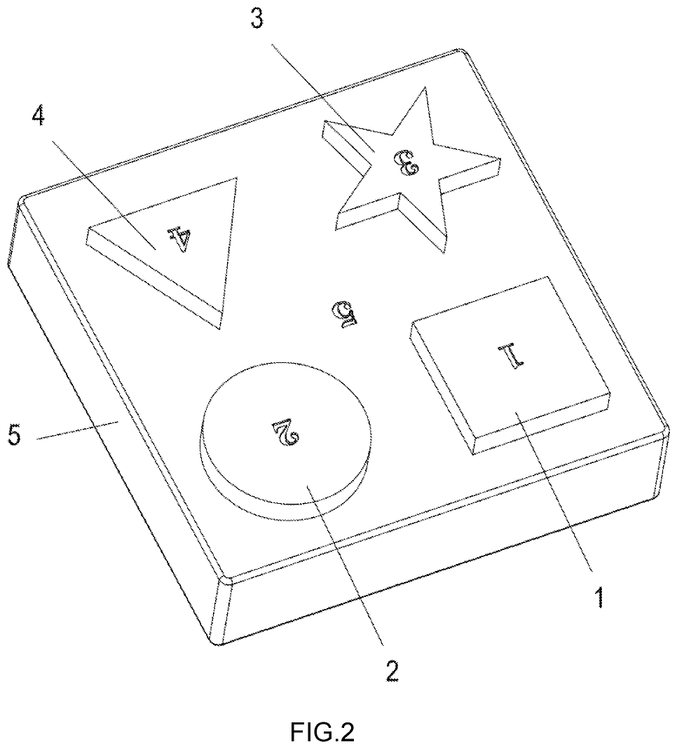

As shown in FIGS. 1 and 2, in this embodiment of the present application, a single product with five components integrated as a whole is manufactured, and the following five molds are provided: A1, A2, A3, A4, and A5. Mold A1 is provided with a mold cavity 11 of a first component 1. Mold A2 is provided with a mold cavity 21 of a second component 2 and a shielding cavity 22 for the first component. Mold A3 is provided with a mold cavity 31 of a third component 3 and shielding cavities 32 for the first component and the second component. Mold A4 is provided with a mold cavity 41 of a fourth component 4 and shielding cavities 42 for the first component, the second component, and the third component. Mold A5 is provided with a mold cavity 51 of a fifth component 5 and positioning cavities 52 for the first component, the second component, the third component, and the fourth component. The mold cavity 51 of the fifth component 5 communicates with the positioning cavities 52.

An injection molding process comprises the following steps:
making the first component 1 in the mold cavity 11 of mold A1 by injection molding;
making the second component 2 in the mold cavity 21 of mold A2 by injection molding, while the first component 1 is shielded by the shielding cavity 22 of mold A2 during injection molding of the second component 2;
making the third component 3 in the mold cavity 31 of mold A3 by injection molding, while the first component 1 and the second component 2 are shielded by the shielding cavities 32 of mold A3 during injection molding of the third component 3;
making the fourth component 4 in the mold cavity 41 of mold A4 by injection molding, while the first component 1, the second component 2 and the third component 3 are shielded by the shielding cavities 42 of mold A4 during injection molding of the fourth component 4; and
placing the first component, the second component, the third component, and the fourth component in the positioning cavities 52, and making the fifth component 5 in the mold cavity 51 of mold A5 by injection molding, after that, the first component 1, the second component 2, the third component 3, the fourth component 4, and the fifth component 5 are connected integrally as a whole, thereby automatically achieving integral assembly of the product.

### Embodiment 2

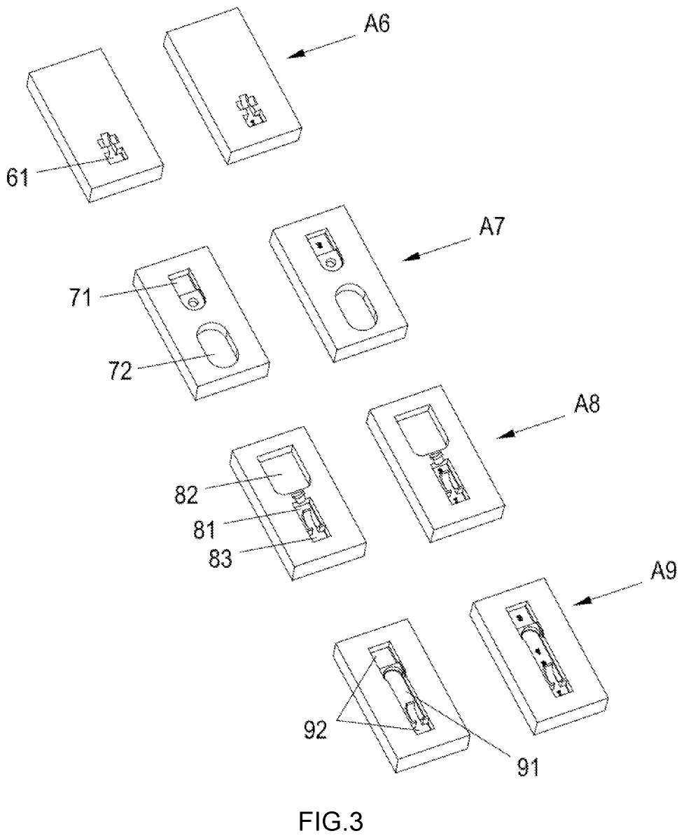

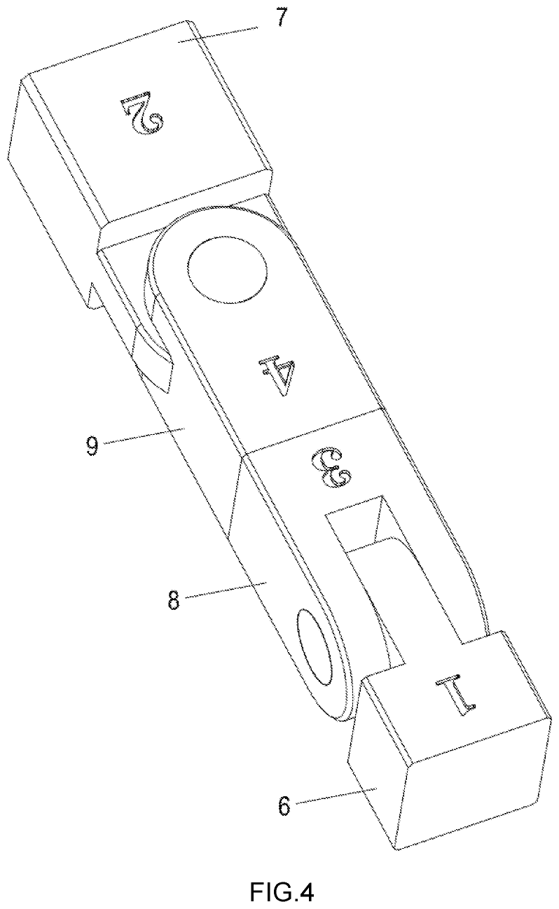

As shown in FIGS. 3 and 4, in this embodiment of the present application, a single product with four components is manufactured, and the following four molds are provided: A6, A7, A8, and A9. Mold A6 is provided with a mold cavity 61 of a sixth component 6. Mold A7 is provided with a mold cavity 71 of a seventh component 7 and a shielding cavity 72 for the sixth component 6. Mold A8 is provided with a mold cavity 81 of an eighth component 8, a shielding cavity 82 for the seventh component 7, and a positioning cavity 83 for the sixth component 6. The mold cavity 81 of the eighth component 8 communicates with the positioning cavity 83 for the sixth component 6. Mold A9 is provided with a mold cavity 91 of a ninth component 9 and positioning cavities 92 for the sixth component 6, the seventh component 7, and the eighth component 8. The mold cavity 91 of the ninth component 9 communicates with the positioning cavities 92 for the sixth component 6, the seventh component 7, and the eighth component 8.

An injection molding process comprises the following steps:
injecting ABS-red plastic material into the mold cavity 61 of mold A6 to form the sixth component 6 by injection molding;
injecting PC-yellow plastic material into the mold cavity 71 of mold A7 to form the seventh component 7 by injection molding, while shielding the sixth component 6 by using the shielding cavity 72 of mold A7 during injection molding of the seventh component 7, and
injecting PA-blue plastic material into the mold cavity 81 of mold A8 to form the eighth component 8 by injection molding, while shielding the seventh component 7 by using the shielding cavity 82 of mold A8 during injection molding of the eighth component 8; after injection molding of the eighth component 8 is completed, the sixth component 6 and the eighth component 8 are connected to form a movable joint mechanism; and
injecting POM-green plastic material into the mold cavity 91 of mold A9 to form the ninth component 9 by injection molding, while positioning the sixth component 6, the seventh component 7, and the eighth component 8 in the positioning cavities 92 of mold A9 during injection molding of the ninth component 9; after injection molding of the ninth component 9 is completed, the sixth component 6, the seventh component 7, the eighth component 8, and the ninth component 9 are connected as a whole, thereby automatically achieving integral assembly of the product, whereas the seventh component 7 and the ninth component 9 are also connected together to form another movable joint mechanism, and the ninth component 9 and the eighth component 8 are connected to form yet another movable joint mechanism.

In this embodiment, the ABS-red plastic material, the PC-yellow plastic material, the PA-blue plastic material, and the POM-green plastic material are exemplarily selected for injection molding. It should be noted that other materials may be selected in other embodiments. For two components that will be in contact with each other during the process of compound injection molding, a same technical effect can be achieved given that a melting point of a material injection-molded later is lower than that of a material injection-molded earlier, and the two materials do not mutually dissolve; accordingly, adjacent components in contact with each other do not mutually melt or dissolve, and the independency and integrity of each component is ensured.

It should be further noted that, on the premise of no contraditions, the embodiments of the present invention and the features described in the embodiments may be combined to obtain new embodiments.

Only preferred embodiments of the present invention are described above, and are not intended to limit the present invention in any form. The protection scope of the present invention shall be defined by the protection scope of the claims. Although the preferred embodiments of the present invention are disclosed above, the embodiments are not intended to limit the present invention. Any of those skilled in the art may make some changes or modifications according to the above disclosed technical content to form equivalent embodiments without departing from the scope of the technical solutions of the present invention. Any simple amendment, equivalent variations, and modifications made on the above embodiments according to the technical essence of the present invention without departing from the contents of the technical solutions of the present invention shall fall within the scope of the technical solutions of the present invention.

What is claimed is:

1. Molds for compound injection molding, comprising at least a first mold, a second mold, and a third mold;
the first mold is provided with a first mold cavity for forming a first component by injection molding;
the second mold is provided with a shielding cavity for shielding the first component and a second mold cavity for forming a second component by injection molding;
the third mold is provided with positioning cavities for positioning the first component and the second component, and a third mold cavity for forming a third component by injection molding; the positioning cavities are in communication with the third mold cavity; a melting point of a plastic injected into the third mold cavity is lower than that of a plastic injected into the first mold cavity and a plastic injected into the second mold cavity, and the plastic injected into the first mold cavity, the plastic injected into the second mold cavity, and the plastic injected into the third mold cavity do not mutually dissolve, thereby allowing the third component to be connected integrally with the first component and the second component to form a one whole piece of product.

2. The molds for compound injection molding of claim 1, wherein each of the first mold, second mold and the third mold comprises an upper mold and a lower mold, and the first mold cavity, the second mold cavity, the third mold cavity, and the shielding cavity are disposed between the upper mold and the lower mold of a respective mold.

3. The molds for compound injection molding of claim 2, wherein a shielding volume of the shielding cavity is larger than a volume of the first component shielded by the shielding cavity, whereas the volume of the first component is defined by an outer contour thereof.

4. A method of compound injection molding, using the molds for compound injection molding according to claim 1, wherein the method comprises the following steps:
S1: making the first component in the first mold cavity of the first mold by injection molding;
S2: making the second component in the second mold cavity of the second mold by injection molding, while the first component is shielded by the shielding cavity of the second mold during injection molding of the second component;
S3: placing the first component and the second component in the positioning cavities of the third mold, and making the third component in the third mold cavity of the third mold by injection molding, so that the third component is integrally connected with the first component and the second component in a one whole piece.
